(19) United States
(12) Patent Application Publication
(10) Pub. No.: US 2024/0101478 A1
(43) Pub. Date: Mar. 28, 2024

(54) SOLVENT-FREE SEALER, PRIMER, AND METHOD FOR CONCRETE SURFACES

(71) Applicant: ADVENTUS MATERIAL STRATEGIES, LLC, DANIEL ISLAND, SC (US)

(72) Inventors: Christopher Shane Kinder, Foster, OK (US); Joseph Drbohlav, III, Inman, SC (US); Brian J. Majeska, Mount Pleasant, SC (US); Joseph J. Jorenc, Philadelphia, PA (US)

(21) Appl. No.: 18/370,448

(22) Filed: Sep. 20, 2023

Related U.S. Application Data
(60) Provisional application No. 63/409,960, filed on Sep. 26, 2022.

(51) Int. Cl. C04B 24/34; C04B 24/08; C04B 24/26; C04B 41/47; C04B 41/48

(52) U.S. Cl. CPC C04B 24/34; C04B 24/08; C04B 24/2641; C04B 41/472; C04B 41/48

(57) ABSTRACT

A 100% solids composition and method for priming or sealing a concrete surface wherein the 100% solids composition is formed of a tree rosin ester resin and a vegetable oil or vegetable oil-derived plasticizer, which are renewable or largely renewable, and wherein the 100% solids composition provides strong adhesion, can be applied by brushing or spraying at a temperature of less than 400° F. without adding a solvent or water thereto, produces substantially no VOCs, requires no time for curing or evaporation, and is ready for traffic or other normal use after cooling.

### RELATED CASE

This application claims the benefit of U.S. Provisional Patent Application Ser. No. 63/409,960 filed on Sep. 26, 2022 and incorporates said provisional application by reference into this document as if fully set out at this point.

### FIELD OF THE INVENTION

The present invention relates to solvent-free compositions and methods for sealing or priming concrete pavements and other concrete surfaces.

### BACKGROUND OF THE INVENTION

Concrete pavements, concrete floors, and other concrete surfaces are not impervious to water. The ingress of water into a concrete surface can produce voids and defects in the concrete and can result in cracking and deterioration. Consequently, various sealer compositions of different types have been used to provide protective top coatings for sealing concrete surfaces to reduce or prevent water ingress.

Alternatively, or in addition, primers, which are often similar to concrete sealer compositions, are typically applied to concrete surfaces before applying other coating materials of various sorts. Primers help to seal concrete surfaces against water ingress and can also improve the bonding and adhesion of the subsequently applied coating materials. The subsequently applied coating materials can, e.g., serve as additional water barriers, provide texture, provide skid resistance, provide colors or designs for aesthetic purposes, or provide markings of various sorts for traffic flow, parking spaces, playground or recreational activities, or for other purposes.

Concrete sealers and primers must provide adequate bonding and adhesion to the concrete surface so that they are not easily removed by the mechanical stresses, e.g., vehicle traffic, or thermal stresses to which the concrete surface may be subjected under normal use. In addition, concrete sealers and primers, especially sealers, should not flow excessively or become overly tacky under high temperature conditions.

It is also desirable that sealers (a) do not undergo cracking at low temperatures due to thermal shrinkage stresses and (b) provide sufficient impact toughness and resistance to avoid fracturing and abrading when subjected to mechanical forces applied, for example, by snowplow blades or snow shovels.

While these same requirements also apply to concrete primers, the degree of toughness, impact resistance, low temperature resistance, and high temperature resistance required for primer compositions will typically not be as great due to the fact that the primer will be shielded from direct exposure to impacts, low temperatures, and sunlight to at least some degree by the coating material which is applied over the primer.

The concrete sealer and primer compositions heretofore available in the art have typically comprised non-renewable, high molecular weight polymers or polymer resins which are dispersed or dissolved in organic solvents or water. Examples of high molecular weight polymers and polymer resins commonly used in concrete sealer and primer compositions have included, but have not been limited to, polyurethanes, epoxy resins, and acrylic polymers and resins.

When a solvent-based or water-based sealer or primer composition is applied to a concrete substrate, not only is it often required that the polymer or polymer resin must cure or set in order to bond to the concrete to form a chemical barrier, but the organic solvent or water must typically first be evaporated. Unfortunately, the evaporation of the organic solvent or water requires a significant amount of time. This is problematic in that, until the organic solvent or water evaporates, and the sealer or primer composition has had sufficient time to cure or set, it is not possible to (a) apply additional coating materials or (b) place the concrete surface in service or otherwise expose the sealer or primer to mechanical stresses.

In addition, the application and drying of organic solvent-based sealers and primers, as well as the curing of some sealer and primer compositions, results in the release of volatile organic compounds (VOCs) which are not only harmful to the environment, but can create health concerns, particularly for workers and other individuals having prolonged exposure to these chemicals. Moreover, although the use of water as a carrier for a concrete sealer or primer composition will generally reduce the release of VOCs during the application and drying processes, most of the polymers and polymer resins which are preferred for use in concrete sealer and primer compositions are insoluble or substantially insoluble in water and therefore require the use of organic solvents.

In addition to the solvent-based and water-based concrete sealers and primers discussed above, some concrete sealers and primers which do not include water or organic solvents have also been available. These solvent-free and water-free compositions are referred to as 100% solids sealers and primers. Examples of 100% solids compositions currently known in the art include some acrylic compositions and epoxy compositions.

The viscosities of the 100% solids acrylic compositions currently known in the art are too high at ambient temperatures to allow thin coatings of the acrylic compositions to be applied to concrete surfaces by brushing or spraying without solvent addition and/or heating. Moreover, these acrylic sealers and primers are not derived from renewable raw materials. To avoid having to heat these 100% solids products to temperatures adequate for application, the products have typically been applied by first dissolving the products in xylenes or other VOC-producing solvents.

The viscosities of the 100% solids epoxy compositions, on the other hand, have typically been sufficiently low to allow the epoxy compositions to be applied at ambient temperatures above 60° F. to 75° F. Unfortunately, however, the epoxy compositions are not derived from renewable sources. Moreover, the epoxy compositions are binary reactive mixtures which must typically be allowed to set, preferably in dry conditions, up to seven days or more in order to fully cure.

Consequently, a need exists for improved compositions and methods for sealing and priming concrete surfaces which (a) are at least substantially solvent-free and water-free, (b) can be applied in thin coatings by brush or spray with only moderate heating, (c) provide strong adhesion to concrete surfaces, (d) produce substantially no VOCs, (e) require no time for curing or solvent evaporation, (f) are produced from renewable raw materials, (g) are ready for traffic or other normal use within a matter of minutes after application, (h) are fully pigmentable, (i) provide good impact resistance, (j) are “self-healing” so that impact marks and defects disappear over a short period of time, and (k) do not shrink excessively during cooling.

### SUMMARY OF THE INVENTION

The present invention provides a 100% solids sealer, a 100% solids primer, a method of sealing or priming a concrete surface, and a primed or coated concrete surface which satisfy the needs and alleviate the problems discussed above. The inventive 100% solids sealer and the inventive 100% solids primer (a) contain no organic solvents or water, (b) can be applied in thin coatings by brush or spray with moderate heating, (c) provide strong adhesion to concrete surfaces, (d) produce substantially no VOCs, (e) require no time for curing or solvent evaporation, (f) are produced from renewable raw materials, (g) are ready for traffic or other normal use, or for top coating, immediately after cooling to ambient temperature (typically within five minutes or less), (h) are readily pigmentable to generally any desired color, (i) provide good impact resistance, (j) are “self-healing”, and (k) do not shrink significantly during cooling.

In one aspect, there is provided a composition for priming or sealing a concrete surface wherein the composition preferably comprises: (a) one or more tree rosin ester resins in a total amount of from 75% to 99% by weight based upon a total weight of the composition; (b) one or more vegetable oil plasticizers and/or vegetable oil-derived plasticizers; (c) the composition being a 100% solids composition; and (d) the one or more vegetable oil plasticizers and/or vegetable oil-derived plasticizers being present in a total amount which provides a viscosity of the composition, without adding a solvent or water to the composition, of not more than 500 cps at a temperature of 300° F.

In another aspect, there is provided a sealer or primer composition for concrete surfaces which has a viscosity of not more than 500 cps, or not more than 400 cps, at a temperature of 300° F. The sealer or primer composition preferably comprises or consists of (a) one or more tree rosin ester resins in a total amount of from 75% to 99% by weight, more preferably from 80% to 99% by weight, based upon a total weight of the sealer or primer composition, (b) one or more vegetable oil or vegetable oil-derived plasticizers in a total amount of from 1% to 25% by weight, more preferably from 1% to 20% by weight, based upon the total weight of the sealer or primer composition, (c) one or more polymer modifiers in a total amount of from 0% to 10% by weight, or from 1% to 10% or from 2% to 8% by weight, based upon the total weight of the sealer or primer composition, (d) one or more color neutralizing materials in a total amount of from 0% to 10% by weight, or from 0.5% to 8% or from 1% to 5% by weight, based upon the total weight of the sealer or primer composition, and (d) one or more pigment materials in a total amount of from 0% to 10% by weight, or from 0.5% to 5% or from 1% to 2% by weight, based upon the total weight of the sealer or primer composition.

In another aspect, there is provided a method of treating a concrete surface which preferably comprises the steps of: (a) forming a 100% solids composition and (b) applying a layer of the 100% solids composition to the concrete surface. The 100% solids composition formed in step (a) preferably comprises (i) one or more tree rosin ester resins in a total amount of from 75% to 99% by weight based upon a total weight of the 100% solids composition and (ii) one or more vegetable oil plasticizers and/or vegetable oil-derived plasticizers in a total amount which provides a viscosity of the 100% solids composition of not more than 500 cps at a temperature of 300° F. The layer of the 100% solids composition is preferably applied to the concrete surface in step (b) in a thickness of from 5 to 50 mils by brushing or spraying at a temperature of less than 400° F. without adding a solvent or water to the 100% solids composition.

In another aspect, there is provided a structure comprising a concrete pavement or other concrete substrate having a layer of the inventive 100% solids sealer or primer composition bonded to a concrete surface of the concrete pavement or other concrete substrate at a thickness in the range of from 5 to 50 mils.

As used herein and in the claims, the term “concrete” refers to Portland cement concrete and other combinations of aggregates and sand bound together by masonry cement.

In another aspect, there is provided a method of sealing or priming a concrete surface which preferably comprises the steps of (a) forming a sealer or primer composition at less than 400° F. and (b) applying a layer of the sealer or primer composition at an application temperature of less than 400° F. to the concrete surface at a thickness of from 5 to 50 mils using a brush or by spraying. The sealer or primer composition can be formed by (i) melt blending, at less than 400° F., one or more tree rosin ester resins with one or more vegetable oil or vegetable oil-derived plasticizers, (ii) optionally adding one or more color neutralizing materials, (iii) optionally adding one or more pigment materials, and (iv) optionally adding one or more polymer modifiers. In the sealer or primer composition formed in step (a) and applied in step (b), the one or more tree rosin ester resins is/are preferably present in a total amount in the range of from 75% to 99% by weight, more preferably from 80% to 99% by weight, based upon the total weight of the sealer or primer composition and the one or more vegetable oil or vegetable oil-derived plasticizers is/are preferably present in a total amount in the range of from 1% to 25% by weight, more preferably from 1% to 20% by weight, based upon the total weight of the sealer or primer composition.

In another aspect, there is provided a structure comprising a concrete pavement or other concrete substrate having a concrete surface to which a layer of the inventive sealer or primer composition is applied and bonded, using the method of the previous paragraph, at a thickness in the range of from 5 to 50 mils.

Further aspects, features, and advantages of the present invention will be apparent to those in the art upon reading the following detailed description of the preferred embodiments.

### DETAILED DESCRIPTION OF THE PREFERRED EMBODIMENTS

The sealer or primer composition of the present invention for sealing or priming concrete surfaces is preferably a 100% solids composition which comprises (a) one or more tree rosin ester resins in a total amount of from 75% to 99% by weight, more preferably from 80% to 99% or from 85% to 95% by weight, based upon a total weight of the sealer or primer composition, (b) one or more vegetable oil or vegetable oil-derived plasticizers in a total amount of from 1% to 25% by weight, more preferably from 1% to 20% or from 5% to 15% by weight, based upon the total weight of the sealer or primer composition, (c) one or more polymer modifiers in a total amount of from 0% to 10% by weight, or from 1% to 10% or from 2% to 8% by weight, based upon the total weight of the sealer or primer composition, (d) one or more color neutralizing materials in a total amount of from 0% to 10% by weight, or from 0.5% to 8% or from 1% to 5% by weight, based upon the total weight of the sealer or primer composition, and (d) one or more pigment materials in a total amount of from 0% to 10% by weight, or from 0.5% to 5% or from 1% to 2% by weight, based upon the total weight of the sealer or primer composition.

As used herein and in the claims, the term “100% solids” means only that the sealer or primer composition is neither solvent-based nor water-based, i.e., the components of the sealer or primer composition as identified herein are not dissolved or suspended in water or an organic solvent. The term “100% solids” does not indicate or imply that the sealer or primer composition is not in a liquid or other flowable form when heated for forming or applying the composition.

Tree rosin ester resins are produced from renewable raw materials and are typically substantially neutral in color. Each of the one or more tree rosin ester resins used in the inventive sealer or primer composition will preferably be an amorphous, esterified (preferably glycol esterified) mixture of low molecular weight compounds produced from the pulping or processing of wood. Tree rosin ester resins typically have softening points of greater than 50° C. and needle penetration values of near 0 dmm at 25° C. The tree rosin ester resin(s) used in the inventive sealer or primer compositions will preferably have (a) softening points in the range of from about 80° C. to about 120° C., more preferably from about 95° C. to about 110° C., and (b) acid numbers of less than 20 mg/g and more preferably less than 15 mg/g.

Examples of tree rosin ester resins suitable for use in the inventive sealer and primer compositions include, but are not limited to, pine-based pentaerythritol ester resins and pine-based glycerol ester resins. The rosin ester material will preferably be or comprise a pine-based pentaerythritol ester resin. An example of a commercially available pine-based pentaerythritol ester resin is WESTREZ Rosin Ester 5101 produced by Ingevity of Charleston, SC.

We have discovered that esterified tree rosins form very strong adhesive bonds with concrete surfaces. Unfortunately, however, esterified tree rosins must be heated to high temperatures to provide viscosities which are low enough for application of thin layers of the resins to concrete surfaces by brush or spraying. In addition, as indicated by their low needle penetration values, tree rosin ester resins, in and of themselves, are much too rigid and inflexible for use as sealers or primers. When cooled, esterified tree rosins also shrink and fracture excessively. Moreover, the impact resistance of the hardened resin is very low, which results in additional fracturing of the hardened resin when struck with a blunt or a sharp object.

However, we have also discovered that these deficiencies of esterified tree rosins for use as sealer or primer materials can by overcome, while also maintaining or substantially maintaining the renewability of these compositions, by blending the tree rosin ester resins with one or more vegetable oil or vegetable oil-derived plasticizers. The vegetable oil plasticizers are renewable, and the vegetable oil-derived plasticizers are formed from renewable vegetable oils. The addition of one or more of the vegetable oil or vegetable oil-derived plasticizers to the one or more tree rosin ester resins of the inventive sealer or primer composition works to reduce the viscosity, increase the needle penetration value, reduce the degree of shrinkage during cooling, and increase the impact toughness of the tree rosin ester resin composition. The addition of the vegetable oil or vegetable oil-derived plasticizers also produces self-healing properties.

Examples of vegetable oil plasticizers suitable for use in the inventive sealer and primer compositions include, but are not limited to, soybean oil, sunflower oil, linseed oil, corn oil, tall oil, and combinations thereof.

Examples of vegetable oil-derived plasticizers suitable for use in the inventive sealer and primer compositions include, but are not limited to: epoxidized esters of vegetable oils (also referred to as functionalized esters derived from vegetable oil fatty acids), tall oil, distilled tall oil, and combinations thereof. Examples of suitable epoxidized esters of vegetable oils include, but are not limited to, epoxidized esters of soybean oil, corn oil, tall oil, and sunflower oil.

Each of the one or more plasticizers used in the inventive sealer or primer composition will preferably be an epoxidized ester of a vegetable oil and will more preferably be an epoxidized methyl ester of a vegetable oil (e.g., an epoxidized methyl ester of soybean oil, an epoxidized methyl ester of corn oil, and epoxidized methyl ester of tall oil, or an epoxidized methyl ester of sunflower oil). The one or more plasticizers used in the inventive sealer or primer composition will more preferably comprise and will most preferably consist of an epoxidized methyl ester of soybean oil.

The one or more vegetable oil or vegetable oil-derived plasticizers will preferably be added to the inventive sealer or primer composition in a total amount such that the viscosity of the sealer or primer composition is reduced sufficiently for applying a thin layer of the sealer or primer composition at an application temperature of less than 400° F. (more preferably not more than 350° F. or not more than 340° F. or not more than 330° F. or from 275° F. to 325° F.) to a concrete surface in a thickness of from 5 to 50 mils (more preferably less than 20 mils or less than 10 mils) by either (a) brushing using, e.g., a paint brush or a similar brush of the type used for maintenance application of coatings or (b) spraying using, e.g., a coatings sprayer of the type used for application of hot melt thermoplastic coatings. The one or more vegetable oil or vegetable oil-derived plasticizers will preferably be added to the inventive sealer or primer composition in a total amount such that the viscosity of the sealer or primer composition at 300° F. will not be more than 500 cps and will more preferably not be more than 300 cps, not more than 250 cps, or not more than 200 cps.

For most formulations and applications, the inventive sealer and primer compositions will preferably comprise or consist of (a) the one or more tree rosin ester resins in a total amount of from 75% to 99% by weight, more preferably from 80% to 99% by weight, and more preferably from 82% to 95% by weight, based upon the total weight of the sealer or primer composition and (b) the one or more vegetable oil or vegetable oil-derived plasticizers in a total amount of from 1% to 25% by weight, more preferably from 1% to 20% by weight, and more preferably from 5% to 15% by weight, based upon the total weight of the sealer or primer composition.

Due to their higher molecular weights and because they are more viscous in nature, vegetable oil triglyceride plasticizers used in the inventive sealer or primer composition such as tall oil or distilled tall oil, will preferably be added to the composition in a higher amount of at least 10% by weight, more preferably from 10% to 20% or at least 15% by weight, based upon the total weight of the inventive sealer or primer composition.

The plasticizers such as epoxidized esters of soybean oil, and more particularly the epoxidized methyl ester of soybean oil, having lower molecular weights and viscosities will preferably be added to the composition in a lower amount of at least 5% by weight, more preferably from 5% to 15% by weight, based upon the total weight of the inventive sealer or primer composition.

Because the inventive sealer or primer composition is preferably solvent-free and water-free and can be formed and applied at temperatures below 400° F., substantially no VOCs (i.e., zero VOCs or not more than trace levels of VOCs) are emitted in the formation, application, and cooling processes. In addition, the ability to form and apply the inventive sealer and primer compositions at such moderate temperatures reduces energy requirements and improves safety.

Examples of preferred polymer modifiers which can optionally be used in the inventive sealer and primer compositions include, but are not limited to (a) polyethylene copolymers which are amorphous in nature such as poly (ethylene-co-vinyl acetate) (EVA) or other copolymers of ethylene with vinyl acetate, (b) poly (ethylene-co-methyl acrylate) (EMAC), poly (ethylene-co-butyl acrylate-co-glycidyl methacrylate) (DOW Elvaloy®), and other copolymers and terpolymers of ethylene with acrylic monomers, and (c) styrene butadiene block copolymers and elastomers based on styrene copolymerized with butadiene and/or isoprene, either in block or random architectures. The polymer modifier preferred for use in the inventive sealer and primer compositions is poly(ethylene-co-methyl acrylate) (EMAC).

The addition of one or more of the preferred polymer modifiers can be used effectively to increase the softening point, needle penetration, and/or impact toughness of the inventive sealer or primer composition, and/or provide improved self-healing, without significantly increasing the viscosity of the composition. By way of example, but not by way of limitation, the one or more polymer modifiers will preferably be added as needed in a total amount effective for (a) increasing the softening point of the inventive sealer to a temperature of at least 60° C., more preferably at least 70° C., (b) increasing the ASTM D5 needle penetration of the inventive sealer to a value of at least 10 diem, more preferably at least 20 dmm, at 25° C., (c) increasing the softening point of the inventive primer to a temperature of at least 50° C., more preferably at least 60° C., and/or (d) increasing the ASTM D5 needle penetration of the inventive primer to a value of at least 10 dmm, more preferably at least 20 dmm, at 25° C. The preferred softening points for the inventive sealer and primer compositions provide resistance to flow and resistance to excessive deformation at high temperatures. The preferred needle penetration values for the inventive sealer and primer compositions prevent excessive shrinkage and cracking during cooling.

For most formulations and applications in which the one or more polymer modifiers is/are used in the inventive sealer or primer composition, the one or more polymer modifiers will preferably be added in a total amount of from 1% to 10% or from 2% to 8% by weight, based upon the total weight of the sealer or primer composition.

The inventive sealer and primer compositions are preferably prepared by melt blending the one or more tree rosin ester resins with the one or more vegetable oil or vegetable oil-derived plasticizers using, e.g., simple low shear paddle agitation or mixing at less than 400° F. (or not more than 350° F. or not more than 340° F., or not more than 330° F., or more preferably from 275° F. to 325° F.) until the components are fully melted and homogenized (typically from about 0.5 to about 2 hours). If one or more polymer modifiers are also used in the inventive sealer or primer composition, the temperature of the resin and plasticizer blend will preferably be maintained while the one or more polymer modifiers is/are preferably added to the resin and plasticizer blend with stirring/mixing using, e.g., simple low shear paddle agitation or mixing until also fully melted and homogenized (typically from about 1 to about 6 hours).

The preferred tree rosin ester resins and the preferred vegetable oil or vegetable oil-derived plasticizers used in the inventive sealer and primer compositions provide resin and plasticizer blends which (a) are substantially clear or transparent at the blending temperature and (b) have water white to slightly yellow shades when cooled and hardened. The inventive resin/plasticizer blends will typically be sufficiently neutral in color to allow pigmentation to generally any desired color by direct addition of the appropriate pigment(s) without prior neutralization of the blends. However, where the resin/plasticizer has a yellowish or brownish shade and/or enhanced color definition is desired, one or more color-neutralizing materials can be added prior to adding the selected pigment(s). Any color-neutralizing and or pigmenting materials used in the inventive sealer or primer compositions will preferably be added to the resin/plasticizer blend prior to the addition of any polymer modifier(s).

Generally any color-neutralizing material can be used in the inventive sealer or primer composition which is effective for whitening or otherwise neutralizing the color of the resin/plasticizer blend without (a) significantly increasing the viscosity or shrinkage of the sealer or primer composition or (b) significantly reducing the adhesion, softening point temperature, needle penetration value, or impact toughness of the composition.

Similarly, generally any pigmenting material can be used in the inventive sealer or primer composition which is effective for providing the color desired without (a) significantly increasing the viscosity or shrinkage of the sealer or primer composition or (b) significantly reducing the adhesion, softening point temperature, needle penetration value, or impact toughness of the composition.

Because the inventive primer compositions will typically be covered and concealed by a topcoat of another coating material, color-neutralizing materials and pigmenting materials typically will not be used in the inventive primer compositions.

Examples of color-neutralizing materials suitable for use in the inventive sealer composition, or primer composition if needed, include but are not limited to titanium dioxide (preferably rutile titanium dioxide), calcium carbonate, blue pigments such as PL Industries ME-2384, and other heat stable blue pigments on inorganic carrier materials. The total amount of any color-neutralizing material(s) used in the inventive sealer or primer compositions will preferably be in the range of from 0.5% to 10% by weight, more preferably from 0.5% to 8% or from 1% to 5% by weight, based upon the total weight of the sealer or primer composition.

Examples of pigmenting materials suitable for use in the inventive sealer composition, or primer composition if needed, include but are not limited to rutile or anatase titanium dioxide, with or without a surface coating applied thereto for enhanced dispersion in oi-based solutions, and Gilsonite powder. The total amount of any pigmenting material(s) used in the inventive sealer or primer compositions will preferably be in the range of from 0.5% to 10% by weight, more preferably from 1% to 5% or from 1% to 2% by weight, based upon the total weight of the sealer or primer composition.

One example of a preferred combination of color-neutralizing and pigmenting materials comprises: (a) the addition of not more than 10% and more preferably from 0.5% to 6% by weight rutile titanium oxide, based upon the total weight of the sealer or primer composition, for color neutralization followed by (b) the addition of from 0.1% to 1.5% by weight, based upon the total weight of the sealer or primer composition, of a blue pigment on a calcium carbonate carrier, and (c) the addition of from 0.3% to 1.5% by weight, based upon the total weight of the sealer or primer composition, of Gilsonite powder to produce a dark blue-gray color.

Any color-neutralizing material(s) used in the inventive sealer or primer compositions will preferably be added to the resin/plasticizer blend, prior to the addition of any polymer modifier(s), by maintaining the blending temperature of the resin/plasticizer blend while adding the color-neutralizing material(s) thereto with low shear paddle mixing.

Any pigmenting material(s) used in the inventive sealer or primer compositions will preferably be added to the resin/plasticizer blend, after the addition of any color-neutralizing material(s) and prior to the addition of any polymer modifier(s), by (1) continuing to maintain the resin/plasticizer blending temperature while (2) adding the pigment material(s) with low shear mixing using, e.g., a simple paddle agitator or mixer until the color is uniform and the blend is fully homogenous (typically about 2 hours).

The fully formulated 100% solids sealer and primer compositions provided by the present invention are thermoplastic compositions which (a) can be used immediately after formation while maintaining the blending temperature of the composition or (b) can be allowed to cool and solidify for use at a later time, and/or for shipment or transport to other locations. For use at a later time and/or at a different location, the inventive solidified sealer or primer composition will preferably be reheated and melted with low shear paddle agitation or stirring until fully fluid.

In either case, the inventive 100% solids sealer or primer composition is preferably applied to the concrete surface by (i) maintaining the composition in or heating the composition to a melted/liquid state at an application temperature of at least 250° F. but less than 400° F. (more preferably not more than 350° F., or not more than 340° F., or not more than 330° F., or more preferably from 275° F. to 325° F.) and (ii) depositing a thin coating of the sealer or primer on the concrete surface by brushing, using, e.g., a paint brush or a similar brush of the type used for maintenance application of coatings, or spraying using, e.g., a coatings sprayer of the type used for application of hot melt thermoplastic pavement markings or coatings. The thickness of the thin coating of the sealer or primer material applied to the concrete surface will preferably be not more than 50 mils and will more preferably be not more than 20 mils, or from 2 to 15 mils or more preferably from 3 to 10 mils.

Prior to applying the inventive sealer or primer composition, the concrete surface will be thoroughly cleaned and can be further prepared or treated by etching and/or by pressure washing.

The following example is provided for purposes of illustration and is not intended to limit the invention in any way.

### Example

Ten compositions (Ex1-Ex10) were tested to determine their suitability for use as sealers or primers for sealing or priming a concrete surface. Composition Ex1 consisted only of Ingevity WESTREZ 5101, a tree rosin ester resin (i.e., a pine-based pentaerythritol ester resin) with no plasticizer, polymer modifier, or other materials added thereto. Compositions Ex2-Ex10 were inventive compositions comprising the components identified in Table 1, wherein all component amounts listed in Table 1 are expressed as percentages by weight (wt %) based upon the total weight of the entire composition. The compositions were prepared using the inventive method described above under identical blending conditions.

As shown in Table 1, the base resin used in each of compositions Ex2-Ex10 was the tree rosin ester resin WESTREZ 5101. Compositions Ex2-Ex8 included varying amounts (from 5 to 12.5 wt %) of ACS EMS-100 (an epoxidized methyl ester of soybean oil, also referred to as epoxidized methyl soyate) as a plasticizer for the tree rosin ester resin. Compositions Ex9 and Ex10 included different amounts of Ingevity ALTAPYNE M28B (distilled tall oil), rather than EMS-100, as the plasticizing material. Compositions Ex6-Ex8 comprised 84 wt % WESTREZ 5101 and 12 wt % EMS-100, with each of compositions Ex6-Ex8 also including 4 wt % of a different EVA, EMAC, or SBS polymer modifier.

TABLE 1

| | | Mass % | | | | | | | | | |
|---|---|---|---|---|---|---|---|---|---|---|---|
| Component | Source | Ex 1 | Ex 2 | Ex 3 | Ex 4 | Ex 5 | Ex 6 | Ex 7 | Ex 8 | Ex 9 | Ex 10 |
| Rosin Ester | Ingevity Westrez 5101 | 100.0 | 95.0 | 92.5 | 90.0 | 87.5 | 84.0 | 84.0 | 84.0 | 90.0 | 85.0 |
| Plasticizer | ACS EMS-100 | 0.0 | 5.0 | 7.5 | 10.0 | 12.5 | 12.0 | 12.0 | 12.0 | 0.0 | 0.0 |
| Plasticizer | Ingevity Altapyne M28B | 0.0 | 0.0 | 0.0 | 0.0 | 0.0 | 0.0 | 0.0 | 0.0 | 10.0 | 15.0 |
| Polymer | Exxon EVA LD761 | 0.0 | 0.0 | 0.0 | 0.0 | 0.0 | 4.0 | 0.0 | 0.0 | 0.0 | 0.0 |
| Polymer | Westlake EMAC 5 | 0.0 | 0.0 | 0.0 | 0.0 | 0.0 | 0.0 | 4.0 | 0.0 | 0.0 | 0.0 |
| Polymer | Dynasol 411 SBS | 0.0 | 0.0 | 0.0 | 0.0 | 0.0 | 0.0 | 0.0 | 4.0 | 0.0 | 0.0 |

The results of the tests performed for compositions Ex1-Ex10 are provided below in Table 2.

TABLE 2

| | Example # | | | | | | | | | |
|---|---|---|---|---|---|---|---|---|---|---|
| | 1 | 2 | 3 | 4 | 5 | 6 | 7 | 8 | 9 | 10 |
| 300° F. | 1270 | 378 | 260 | 170 | 123 | 260 | 330 | 635 | 243 | 145 |
| Viscosity | | | | | | | | | | |
| (cps) | | | | | | | | | | |
| Soft Point | 101 | 77 | 70 | 63.5 | 53 | 62 | 67 | 62 | 71 | 61.5 |
| (° C.) | | | | | | | | | | |
| 25° C. | 0 | 0 | 1 | 10 | 25 | 20 | 19 | 19 | 1 | 10 |
| Needle | | | | | | | | | | |
| Penetration | | | | | | | | | | |
| (dmm) | | | | | | | | | | |
| Impact | Very | Poor | Poor | Poor; self | Acceptable; | Acceptable; | Acceptable; | Acceptable; | Poor | Poor; |
| Toughness | Poor | | | healing | self healing | self healing | self healing | self healing | | self |
| | | | | | | | | | | healing |
| Shrinkage | Severe | Poor | Poor | Acceptable | Acceptable | Acceptable | Acceptable | Acceptable | Poor | Acceptable |
| Upon | | | | | | | | | | |
| Cooling | | | | | | | | | | |

The softening points of the compositions were determined in accordance with ASTM D36. The needle penetration values were determined in accordance with ASTM D5 at 25° C.

The impact toughness of each composition was determined by applying a coating of the composition at 300° F. to a concrete paver at a thickness of about 10 mils using a paint brush and then allowing the composition to cool, bond, and harden for 15 minutes. The treated surface was then struck gently with the edge of a metal paint scraper. Poor impact toughness was indicated by easily fracturing the bonded composition with particles of the solid coating being ejected from the surface. Acceptable impact performance was indicated where there was evidence that the impact had occurred, but no loose particles were dislodged from the surface. Self-healing indicates that any impact marks or defects disappeared after a short period of time (generally 2-6 hours) due to the flow of the composition at the region of the impact.

The shrinkage of each composition was assessed by filling a metal soup can to ⅓ full with the composition at 300° F. while fully fluid. The composition was allowed to cool for 30 minutes at ambient conditions and was then placed in a refrigerator at 40° F. for further cooling. The compositions which exhibited high shrinkage stress levels emitted audible cracking or popping noises as they cooled, with evidence of shrinkage stress fracturing also being visibly apparent. The compositions which provided significantly reduced shrinkage did not emit audible cracking or popping noises while cooling and did not show visual evidence of fractures or cracking.

Ex1 demonstrated the inability of tree rosin ester resins alone, without the use of a suitable plasticizer in accordance with the present invention, to function as sealers or primers for concrete surfaces. The impact toughness and shrinkage of composition Ext upon cooling were very poor. In addition, the needle penetration value of zero determined for Ex1 was indicative of a material that is far too rigid and inflexible for use as a concrete sealer or primer. Further, the viscosity of Ex1 was much too high for effective application of a thin coating at a moderate temperature of 300° F.

Compositions Ext and Ex3, which respectively included 5 wt % and 7.5 wt % of EMS-100 (epoxidized methyl soyate) as a plasticizing material, each showed that these low concentrations of EMS-100 provided significant improvements in viscosity with good softening points, but did not significantly improve the needle penetration, impact toughness, or shrinkage of the tree rosin ester base resin.

Compositions Ex4 and Ex5, which included higher amounts (10 wt % and 12.5 wt % respectively) of EMS-100 provided good viscosities, improved impact toughness and/or self-healing, and acceptable shrinkage. The softening point of Ex4 was also acceptable for most sealing applications. Moreover, the softening points of both Ex 4 and Ex5 were acceptable for use as primers due to the fact that the coating material which is applied over the primer will typically shield the primer to some degree.

Compositions Ex6, Ex7, and Ex8 demonstrated the improvements provided by adding suitable polymer modifiers to the inventive compositions. The polymer modifiers used in Ex6, Ex7, and Ex8 each provided a higher softening point, a concurrent increase in needle penetration, and improvements in impact toughness and shrinkage. The viscosity of Ex8, which used an SBS (styrene butadiene styrene) terpolymer modifier was excessive compared to Ex6 (which used an ethylene vinyl acetate copolymer modifier) and Ex7 (which used an ethylene methacrylate copolymer modifier). Except for the high viscosity of Ex8, the properties of each of compositions Ex6, Ex7, and Ex8 were acceptable for use as either concrete sealing or a concrete priming compositions. Composition Ex7, which provided the highest softening point while maintaining a viscosity of well below 500 cps at 300° F., was the most preferred of the three modified compositions.

Compositions Ex9 and Ex10 demonstrated the use of distilled tall oil as an alternative plasticizer, although higher levels of the distilled tall oil were required to achieve properties very similar to those demonstrated by compositions Ex4 and Ex5 which used lower levels of EMS-100 (epoxidized methyl soyate).

Thus, the present invention is well adapted to carry out the objects and attain the ends and advantages mentioned above as well as those inherent therein. While presently preferred embodiments have been described for purposes of this disclosure, numerous changes and modifications will be apparent to those in the art. Such changes and modifications are encompassed within this invention as described herein and in the claims.

1. A composition for priming or sealing a concrete surface comprising:
one or more tree rosin ester resins in a total amount of from 75% to 99% by weight based upon a total weight of the composition;
one or more vegetable oil plasticizers and/or vegetable oil-derived plasticizers;
the composition being a 100% solids composition; and
the one or more vegetable oil plasticizers and/or vegetable oil-derived plasticizers being present in a total amount which provides a viscosity of the composition, without adding a solvent or water to the composition, of not more than 500 cps at a temperature of 300° F.

2. The composition of claim 1 further comprising the total amount of the one or more vegetable oil plasticizers and/or vegetable oil-derived plasticizers being in a range of from 1% to 25% by weight based upon the total weight of the composition.

3. The composition of claim 2 further comprising the one or more vegetable oil plasticizers and/or vegetable oil-derived plasticizers being one or more of soybean oil, sunflower oil, linseed oil, corn oil, tall oil, epoxidized esters of vegetable oils, and/or distilled tall oil.

4. The composition of claim 2 further comprising the total amount of the one or more vegetable oil plasticizers and/or vegetable oil-derived plasticizers being an amount which reduces the viscosity of the composition, without adding a solvent or water to the composition, to a value of not more than 300 cps at a temperature of 300° F.

5. The composition of claim 2 further comprising the one or more vegetable oil plasticizers and/or vegetable oil-derived plasticizers being one or more epoxidized esters of soybean oil, corn oil, tall oil, and/or sunflower oil.

6. The composition of claim 1 further comprising the one or more tree rosin ester resins being one or more pine-based pentaerythritol ester resins and/or pine-based glycerol ester resins.

7. The composition of claim 6 further comprising the one or more tree rosin ester resins comprising a pine-based pentaerythritol ester resin.

8. The composition of claim 1 further comprising one or more polymer modifiers in a total amount of from 1% to 10% by weight based upon the total weight of the composition.

9. The composition of claim 8 further comprising the one or more polymer modifiers comprising poly(ethylene-co-methyl acrylate).

10. The composition of claim 1 further comprising one or more color neutralizing materials in a total amount of from 0.5% to 8% by weight based upon the total weight of the composition.

11. The composition of claim 1 further comprising one or more pigment materials in a total amount of from 0.5% to 5% by weight based upon the total weight of the composition.

12. A method of treating a concrete surface comprising steps of:
a) forming a 100% solids composition comprising
one or more tree rosin ester resins in a total amount of from 75% to 99% by weight based upon a total weight of the 100% solids composition and
one or more vegetable oil plasticizers and/or vegetable oil-derived plasticizers in a total amount which provides a viscosity of the 100% solids composition of not more than 500 cps at a temperature of 300° F.;
b) applying a layer of the 100% solids composition to the concrete surface, in a thickness of from 5 to 50 mils, by brushing or spraying at a temperature of less than 400° F. without adding a solvent or water to the 100% solids composition.

13. The method of claim 12 further comprising:
the total amount of the one or more vegetable oil plasticizers and/or vegetable oil-derived plasticizers being in a range of from 1% to 25% by weight based upon the total weight of the 100% solids composition and
the one or more vegetable oil plasticizers and/or vegetable oil-derived plasticizers being one or more of soybean oil, sunflower oil, linseed oil, corn oil, tall oil, epoxidized esters of vegetable oils, and/or distilled tall oil.

14. The method of claim 12 further comprising:
the one or more tree rosin ester resins being one or more pine-based pentaerythritol ester resins and/or pine-based glycerol ester resins and
the one or more vegetable oil plasticizers and/or vegetable oil-derived plasticizers being one or more epoxidized esters of soybean oil, corn oil, tall oil, and/or sunflower oil.

15. The method of claim 12 further comprising the total amount of the one or more vegetable oil plasticizers and/or vegetable oil-derived plasticizers being an amount which reduces the viscosity of the 100% solids composition to a value of not more than 300 cps at a temperature of 300° F.

16. The method of claim 12 further comprising the 100% solids composition formed in step (a) also including one or more polymer modifiers in a total amount of from 1% to 10% by weight based upon the total weight of the 100% solids composition.

17. The method of claim 12 further comprising the 100% solids composition formed in step (a) also including one or more color neutralizing materials in a total amount of from 0.5% to 8% by weight based upon the total weight of the 100% solids composition.

18. The method of claim 12 further comprising the 100% solids composition formed in step (a) also including one or more pigment materials in a total amount of from 0.5% to 5% by weight based upon the total weight of the 100% solids composition.

19. The method of claim 12 further comprising a step, after step (b), of applying a coating material on top of the layer of the 100% solids composition.

20. The method of claim 12 further comprising the layer of the 100% solids composition being applied to the concrete surface in step (b) at a temperature of not more than 350° F.
